(19) United States
(12) Patent Application Publication
(10) Pub. No.: US 2009/0003359 A1
(43) Pub. Date: Jan. 1, 2009

(54) Selecting a Visited Bearer Manager (VBM)

(75) Inventors: Parviz Yegani, Danville, CA (US); Jonathan D. Rosenberg, Freehold, NJ (US); Vojislav Vucetic, Holmdel, NJ (US)

Correspondence Address: BAKER BOTTS L.L.P., 2001 ROSS AVENUE, SUITE 600, DALLAS, TX, 75201-2980, US

(73) Assignee: Cisco Technology, Inc., San Jose, CA (US)

(21) Appl. No.: 11/771,335

(22) Filed: Jun. 29, 2007

(51) Int. Cl. H04L 12/66

(52) U.S. Cl. 370/401

(57) ABSTRACT

In one embodiment, a method includes, generating a first value at an Internet Protocol gateway (IPGW) corresponding to an identifier (ID) of an access terminal (AT). The method further includes identifying a first one of a plurality of visited bearer managers (VBMs) based on a correlation between the first value and a first Internet Protocol (IP) address of the first VBM and determining usability of the first VBM for the AT, the determination of the usability of the first VBM taking into account dynamic conditions at the first VBM. If the first VBM is usable for the AT, connection is allowed between the AT and the first VBM. If the first VBM is unusable for the AT, a second value corresponding to a modification of the ID is generated and a second one of the VBMs is identified.

### TECHNICAL FIELD

The present disclosure relates generally to communication systems.

### BACKGROUND

Networking architectures have grown increasingly complex in communications environments. In addition, the mobility of end users wishing to communicate in a network environment has driven the need for network systems that can efficiently accommodate the increase in mobile network traffic. Moreover, as the number of end users continues to increase, proper call routing and efficient management of network assets and data flows becomes an important factor in overall network operability. This is particularly true in mobile service provider network architectures where end users can roam from network to network.

### BRIEF DESCRIPTION OF THE DRAWINGS

FIG. 1 illustrates an example system for selecting a visited bearer manager (VBM); and

FIG. 2 illustrates an example method for selecting a VBM.

### DESCRIPTION OF EXAMPLE EMBODIMENTS

Overview

In one embodiment, a method includes, generating a first value at an Internet Protocol gateway (IPGW) corresponding to an identifier (ID) of an access terminal (AT). The method further includes identifying a first one of a plurality of visited bearer managers (VBMs) based on a correlation between the first value and a first Internet Protocol (IP) address of the first VBM and determining usability of the first VBM for the AT, the determination of the usability of the first VBM taking into account dynamic conditions at the first VBM. If the first VBM is usable for the AT, connection is allowed between the AT and the first VBM. If the first VBM is unusable for the AT, a second value corresponding to a modification of the ID is generated and a second one of the VBMs is identified based on a correlation between the second value and a second IP address of the second VBM. The method further includes determining usability of the second VBM for the AT, the determination of the usability of the second VBM taking into account dynamic conditions at the second VBM, and if the second VBM is usable for the AT, connection is allowed between the AT and the first VBM.

Description

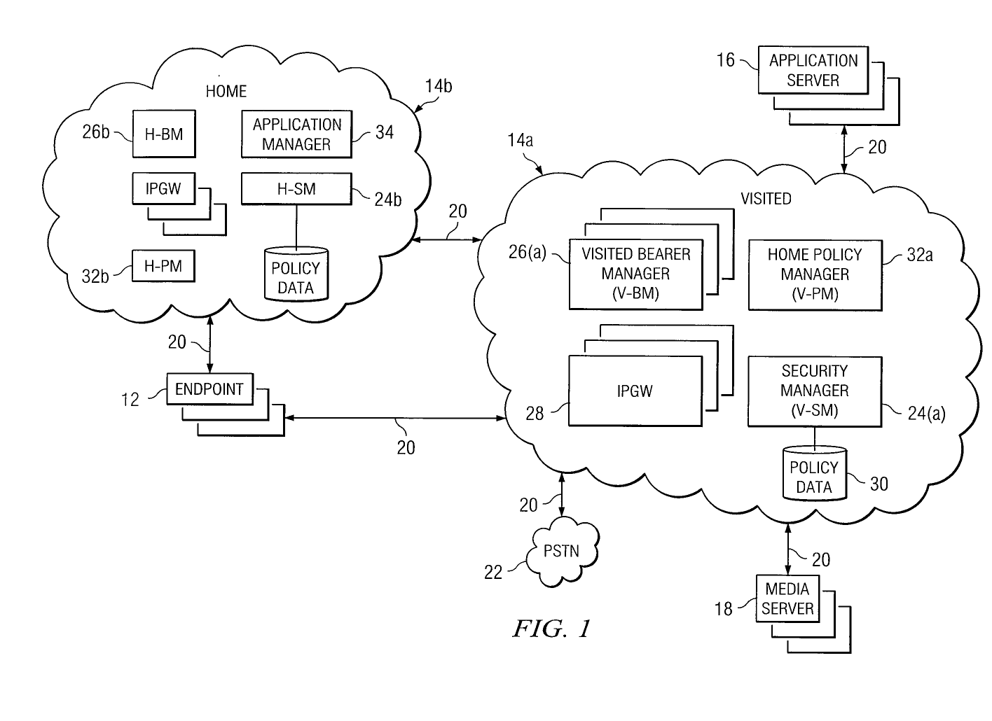

FIG. 1 illustrates an example system 10 for selecting a VBM. System 10 includes a number of network components coupled to and contained within a network 14. In particular embodiments, network 14 may include one or more local area networks (LAN), one or more wireless LANs (WLAN), one or more wide area networks (WAN), one or more metropolitan area networks (MAN), a portion of the Internet, or another form of network or a combination of two or more such networks. The present disclosure contemplates any suitable network 14 or combination of networks 14. As an example and not by way of limitation, one or more portions of network 14 may provide a Code Division Multiple Access (CDMA) Evolution Data Optimized (EVDO)-based wireless network infrastructure. One or more portions of network 14 may have a Multimedia Domain Plus (MMD+), Advances to IP Multimedia Subsystem (A-IMS), or similar system architecture. In particular embodiments, components of network 14 are distributed across multiple cities or geographical regions. Components of network 14 may use IP, SIP, or both (possibly in addition to one or more other protocols) to communicate with each other. Herein, reference to IP encompasses any suitable version of IP, such IPv4, Mobile IPv6, or a combination of the two, where appropriate. In particular embodiments, network 14 is a packet-switched network 14, and components of network 14 communicate packets to and from each other. As an example and not by way of limitation, a packet communicated from one or more first components of network 14 to one or more second components of network 14 may include bearer data (such as for example, audio data, video data, voice data, other data, or a combination of such bearer data), signaling data, or both. Herein, reference to a packet encompasses a cell, a frame, a datagram, or another unit of data or a combination of two or more such packets, where appropriate.

In particular embodiments, network 14 may be represented by multiple distinct, but interconnected networks that share components or distinctly contain similar components. Distinction between networks may be defined, for example, by geographic location, individual ownership, differing network architectures, or other distinction. As an example and not by way of limitation, system 10 may contain a visited network 14a and a home network 14b (e.g., visited network 14a representing a network system located in a foreign country, and home network 14b representing a network system located in a particular subscriber's home country).

Example components of system 10 include one or more endpoints 12 coupled to visited network 14a and home network 14b. Additionally, one or more application servers 16, one or more media servers 18, and the Public Switched Telephone Network (PSTN) 22 are also coupled to visited network 14a which is itself coupled to home network 14b. Endpoints 12 communicate with each other and with application servers 16, media servers 18, and PSTN 22 via use of networks 14a and 14b. In particular embodiments, one or more of the components coupled to or contained in visited network 14a may be simultaneously or alternatively coupled to or contained in home network 14b and vice versa.

In particular embodiments, one or more links 20 couple one or more endpoints 12 to visited network 14a. Similarly, one or more links 20 couple one or more application servers 16, one or more media servers 18, PSTN 22, visited network 14a and home network 14b together. In particular embodiments, links 20 may each include one or more wireline, wireless, or optical links 20. In particular embodiments, one or more links 20 each include a LAN, a WLAN, a WAN, a MAN, a radio access network (RAN), a portion of the Internet, or another link 20 or a combination of two or more such links 20. As an example and not by way of limitation, a link 20 between one or more endpoints 12 (such as, for example, CDMA cellular telephones) and visited network 14a may include a RAN that has a particular coverage area and provides Layer 2 mobile access, quality of service (QoS), mobility, and handoff services in its particular coverage area. The RAN may include one or more radio resource managers (RRMs) and one or more base transceiver stations (BTSs). The present disclosure contemplates any suitable links 20. In particular embodiments, one or more endpoints 12 share with each other one or more portions of one or more links 20 to visited network 14a. Similarly, in particular embodiments, one or more applications servers 16, media servers 18, or both share with each other one or more portions of one or more links 20 to visited network 14a. In particular embodiments, one or more first links 20 may differ from one or more second links 20. As an example and not by way of limitation, a first link 20 including a RAN may couple one or more endpoints 12 (such as, for example, CDMA cellular telephones) to visited network 14a and a second link 20 including a PSTN gateway may couple PSTN 22 to visited network 14a. In particular embodiments, one or more links 20 may each include one or more components that reside in visited network 14a. A link 20 need not necessarily terminate outside network 14. The present disclosure contemplates any suitable arrangements of any suitable links 20 coupling endpoints 12, application servers 16, media servers 18, PSTN 22, visited network 14a, and home network 14b together.

In particular embodiments, one or more application servers 16 coupled to visited network 14a provide one or more applications to one or more endpoints 12. As an example and not by way of limitation, an application may include one or more Session Initiation Protocol (SIP)-based communication applications, such as, for example, Internet Protocol (IP) telephony. As another example, an application may include one or more non SIP-based applications, such as, for example, video streaming, gaming, or collaboration. Endpoint 12 may invoke a SIP-based communication application at application server 16 through an application manager residing in home network 14b. The application manager may be a hardware, software, or embedded logic component or a combination of two or more such components facilitating integration of the application domain of home network 14 into the policy frameworks and the security infrastructures of networks 14a or 14b. Endpoint 12 or one or more predetermined triggers may invoke a non SIP-based application at application server 16 directly, but a policy manager 32 in network 14a or 14b may manage access to the non SIP-based application. In particular embodiments, one or more first application servers 16 provide SIP-based communication applications and one or more second application servers 16 provide non SIP-based communication applications. In particular embodiments, application servers 16 providing SIP-based communication applications reside in home network 14b on top of the application manager. In particular embodiments, an application server 16 is either stand-alone or user-specific. As an example and not by way of limitation, a stand-alone application server 16 may provide general application services, which users at endpoints 12 may invoke explicitly by reference to the name of their associated services, for example, via a specific SIP uniform resource identifier (URI), a telephone number, or a dial string. Provision of the general application services need not involve originating or terminating call/request treatment. A user-specific application server 16 may provide application services that involve originating or terminating call/request treatment. The present disclosure contemplates any suitable application servers 16 providing any suitable applications to endpoints 12.

In particular embodiments, media servers 18 provide one or more media processing functions to one or more application servers 16. As an example and not by way of limitation, media processing functions may include interactive voice response (IVR), mixing functions, transcoding, announcement functions, messaging functions, and other functions supporting bearer-related services. Media processing functions may be service enablers, e.g., coarse-grained application components that tend to lack utility by themselves, but are useful to other applications. In particular embodiments, one or more media servers 18 are integrated into one or more application servers 16. In particular embodiments, one or more media servers 18 are stand-alone resources relative to one or more application servers 16 subject to control by typical SIP procedures, such as the use of INVITE messages.

Endpoint 12 may be any hardware-based or software-based device or combination of such devices whereby a user may send or receive data via networks 14a or 14b. In particular embodiments, endpoint 12 enables a user to communicate with one or more users at one or more other endpoints 12, communicate with one or more users at one or more telephones or other devices across PSTN 22, or both. As an example and not by way of limitation, an endpoint 12 may be a CDMA or other cellular telephone or smart phone. An endpoint 12 may be a mobile IP telephone. An endpoint 12 may be a dual-mode telephone including both CDMA or other cellular-telephone functionality and mobile IP telephone functionality. An endpoint 12 may be a personal digital assistant (PDA) including CDMA or other cellular-telephone functionality, mobile IP telephone functionality, or both. An endpoint 12 may be a network-enabled media player including CDMA or other cellular-telephone functionality, mobile IP telephone functionality, or both. Herein, reference to media encompasses audio, video, other media, or a combination of two or more such media. An endpoint 12 may be a network-enabled still or video camera. An endpoint 12 may be a desktop, notebook computer system, or PC card which may ran or have access to a telephony application such as, for example, SKYPE. An endpoint 12 may include one or more unattended or automated systems (such as for example, video cameras, video monitors, or gateways or other intermediate components) or other devices capable of communicating to or receiving communications from network 14. Herein, reference to an endpoint 12 encompasses one or more access terminals (ATs), and vice versa, where appropriate. The present disclosure encompasses any suitable endpoints 12.

Each endpoint 12 may be associated with a unique identifier (ID) such as a Mobile Station Identifier (MSID). In particular embodiments, the MSID associated with endpoint 12 is assumed to be known to IP gateway 28 once endpoint 12 attaches to network 14 for the first time. An example MSID could be an International Mobile Station Identifier (IMSI), a Media Access Control (MAC) address, a Unicast Access Terminal Identifier (UATI), a Mobile Equipment Identifier (MEID) or another numeric or alphanumeric identifier used to uniquely identify endpoint 12 or one or more service flows initiated by endpoint 12. In particular embodiments an ID could comprise an endpoint-independent numeric identifier associated with a particular user subscription or user account on network 14. In particular embodiments, the service flow ID may be used as a handle for network 14 to allocate a particular visited bearer manager for a particular requested service (e.g., for optimal routing of the user traffic).

In particular embodiments, one or more endpoints 12 each includes a posture agent. A posture agent includes a hardware, software, or embedded logic component or a combination of two or more such components at an endpoint 12 for collecting information concerning the security posture of endpoint 12 and communicating the collected information to security manager 24.

In particular embodiments, visited network 14a and home network 14b each include a security manager 24, one or more bearer managers 26, a policy manger 32, a services data manager 30 and one or more IP gateways 28. As described above, in particular embodiments, network 14 also includes a PSTN gateway facilitating communication between network 14 and PSTN 22.

In particular embodiments, security manager 24 is a central access point for security services in network 14. Security manager 24 includes a hardware, software, or embedded logic component or a combination of two or more such components for assessing a security posture of each of endpoints 12. In particular embodiments, security manager 24 may receive security posture information regarding endpoint 12 from a posture agent residing on endpoint 12 and thereafter communicate a posture assessment of endpoint 12 to Policy manager 32. Policy manager 32 may use the security posture assessment (possibly in addition to one or more other criteria) to make one or more policy decisions concerning a level of access to network 14 to grant to endpoint 12. In particular embodiments, access to home network 14b may be governed by home security manager 24b operating in conjunction with home policy manager 32b. In particular embodiments, access to visited network 14a may be governed by visited security manager 24a operating in conjunction with visited policy manager 32a. One of ordinary skill in the art will appreciate that the present embodiment for network access is described for the sake of explanatory simplicity and will further appreciate that access to networks 14a and 14b may be governed by any suitable arrangement of visited and home components operating in conjunction with one another.

One or more bearer managers 26 are also contained in system 10. Bearer managers 26 include hardware, software, or embedded logic components or a combination of two or more such components for managing bearer paths in network 14. Generally speaking, managing bearer traffic in network 14 may, as an example and not by way of limitation, include establishing, monitoring, and taking down bearer paths between or among components of system 10. In particular embodiments, bearer managers 26 also facilitate operations such as signal processing and allocating network resources for endpoints 12. In particular embodiments, one or more bearer managers 26 reside at one or more servers in network 14. In particular embodiments, bearer manager 26 includes a Serving General Packet Radio Services (GPRS) Support Node (SGSN), a home/foreign agent, a mobile gateway, a Mobile IPv6 node, a Packet Data Serving Node (PDSN), or another component or a combination of two or more such components. Bearer managers 26 may use any suitable protocol (such as, for example, an IP multimedia subsystem (IMS) protocol) to communicate with one or more other components of system 10.

In particular embodiments, multiple visited bearer managers 26a and home bearer managers 26b are respectively distributed throughout visited network 14a and home network 14b. As an example and not by way of limitation, endpoint 12 may connect, through mobile IP registration procedures, to visited network 14a via visited bearer manager 26a and to home network 14b via home bearer manager 26b; thus, visited bearer manager 26a and home bearer manager 26b may act as anchor points for endpoint 12 in their respective home and visited networks. As an example and not by way of limitation, an anchor point may be viewed as a fixed server residing in network 14 to which packets destined for endpoint 12 may be delivered. Because of their role as the IP anchor points, bearer managers 26 may also serve as the natural enforcement points for a host of network policies, including QoS, accounting, and mobility. In particular embodiments, bearer managers 26 provide security functions, such as firewall, intrusion detection, and Distributed Denial of Service (DDOS) attack prevention. In particular embodiments, bearer managers 26 may also act as a repositories for network presence information, including the roaming states for endpoint 12 (e.g., its cell site location, etc.).

System 10 may allow endpoint 12 to concurrently connect to visited network 14a and home network 14b by simultaneously engaging two anchors (e.g., a home anchor in home network 14b and a visited anchor in visited network 14b). By providing dual anchors, communication system 10 may improve the level network performance delivered to endpoint 12 by tailoring the use of particular resources in both visited network 14a and home network 14b to the specific applications being invoked by endpoint 12. As an example and not by way of limitation, endpoint 12 may use visited network 14a for some applications, and home network 14b for other applications. When anchoring in visited network 14a, endpoint 12 may experience lower latency and packet loss while roaming, thus facilitating use of certain applications such as real-time VoIP. When anchoring in home network 14b, endpoint 12 may use certain services or features supplied by home network 14b that are not otherwise offered by visited network 14a (e.g., firewalling, filtering, etc.) thus facilitating use of service-specific applications such as web browsing.

In particular embodiments, selection and assignment of a bearer managers may occur via an IP gateway 28. IP gateway 28 includes hardware, software, or embedded logic components or a combination of two or more such components which provide an interface between visited network 14a, home network 14b, a RAN, or one or more other networks or other systems outside network 14. In particular embodiments, multiple IP gateways 28 are geographically distributed throughout visited network 14a and home network 14b. As an example and not by way of limitation, IP gateway 28 may provide an interface between visited network 14a and a RAN (contained in link 20) coupling one or more endpoints 12 to visited network 14a. IP gateway 28 may include functionality for encoding, decoding, and transcoding, as needed, to enable the communication of data between networks 14a and 14b, and the RAN. In particular embodiments, IP gateway 28 uses an A10, A11, or A12 interface according to an appropriate CDMA scheme to communicate with one or more RANs. In particular embodiments, IP gateway 28 participates in handoffs of endpoint 12 between RANs, handoffs of endpoint 12 to other IP gateways 28, and in selection and assignment of bearer managers 26 to endpoints 12.

Multiple IP gateways 28 may reside in network 14 and each IP gateway 28 may have a one-to-many relationship with bearer managers 26 residing in the same domain (e.g., visited network 14a or home network 14b). In particular embodiments, the connectivity between IP gateways 28 and bearer managers 26 may over lap. As an example and not by way of limitation, each IP gateway 28 in visited network 14a may have identical and overlapping access to every visited bearer manager 26a in visited network 14a. As another example and not by way of limitation, some IP gateways 28 in visited network 14a may have access to all visited bearer managers 26a while other IP gateways 28 in visited network 14a may only have access to a subset of visited bearer managers 26a. One of ordinary skill in the art will appreciate that the present examples are described for the sake of explanatory simplicity and will further appreciate that any suitable connectivity between IP gateways 28 and bearer managers 26 is contemplated.

In particular embodiments, IP gateway 28 may be responsible for assigning to endpoint 12 an IP address of a home bearer manager 26b in home network 14b (a home address). IP gateway 28 may operate in conjunction with one or more components of networks 14a and 14b to provide endpoint 12 with a home address. For instance, IP gateway 28 may provide endpoint 12 with a home address using Extensible Authentication Protocol (EAP) procedures. As part of the authentication procedures, IP gateway 28 may pass the identity and security posture asserted by endpoint 12 to visited security manager 24a. In particular embodiments, visited security manager 24a may use the domain portion of the subscriber identifier to locate and send information to home security manager 24b in home network 14b. Upon receiving information regarding endpoint 12 from visited security manager 24a, home security manager 24b and home policy manager 32a may engage in steps to authenticate endpoint 12 to home network 14b. Upon completing the EAP exchange with home network 14b, IP gateway 28 may learn, among other things, the identity of endpoint 12 (e.g., the MSID of endpoint 12), the identity of the subscriber using endpoint 12 (if endpoint 12 is integrated), and the home address of the home bearer manager 26b assigned to the subscriber in the home network 14b. In particular embodiments, IP gateway 28 may assign and transmit the home address to endpoint 12 via an RRQ/RRP exchange.

In particular embodiments, IP gateway 28 may be responsible for assigning to endpoint 12 an IP address of a visited bearer manager 26a in visited network 14a (a visited address). The visited address may be used as the Care of Address (CoA) when establishing a mobility binding between endpoint 12 and home bearer manager 26b. As an example and not by way of limitation, one or more endpoints 12 may individually request visited addresses from IP gateway 28 by sending Dynamic Host Protocol Procedure (DHCP) queries to IP gateway 28. IP gateway 28 may use a distributive selection technique to assign visited addresses to endpoints 12 such that each visited bearer manager 26a supports an approximately equal number of endpoints 12.

The distributive selection technique used by IP gateway 28 to achieve the approximately even distribution of endpoints 12 among visited bearer managers 26a may be any logical, mathematical, or other method, of allocating the IP addresses respectively associated with visited bearer managers 26a amongst endpoints 12 such that each visited bearer manager 26a is responsible for handling substantially a similar number of endpoints 12. As an example and not by way of limitation, the distributive selection technique may include a selection algorithm (e.g., a hash algorithm or other mathematical algorithm) based upon the MSIDs associated with endpoints 12. The selection algorithm may be used to generate a hash value (sometimes referred to as a visited bearer manager entry) corresponding the MSID of each endpoint 12. The distributive selection technique may also include a configuration table (discussed below) to be used in conjunction with the hash values to identify the IP addresses of the respective visited bearer managers to be assigned to endpoints 12.

As an example and not by way of limitation, the distributive selection technique employed by IP gateway 28 may include a hash algorithm that receives, as input, a MSID (e.g. an IMSI) associated with endpoint 12 and generates, as output, a value (e.g., a visited bearer manager entry V-BM#) that may be used to identify a particular visited bearer manager 26a in visited network 14a. IP gateway 28 may correlate the value with a configuration table containing a list of visited bearer manager IP addresses and thereby designate a visited address for endpoint 12. In particular embodiments, when multiple endpoints 12 (each having a unique MSID) request visited addresses on visited network 14a, the distributive effects inherent in the selection algorithm may generate resultant values that will distribute endpoints 12 evenly among bearer managers 26a. As a result, particular embodiments may minimize manual provisioning of visited bearer mangers 26a in network 14 and particular embodiments may provide load balancing across multiple visited bearer managers 26a serving multiple endpoints 12.

Each IP gateway 28 may maintain a configuration table with the IP addresses of visited bearer managers 26a as follows:

| Visited Bearer Manager Entry | Visited Bearer Manager |
|---|---|
| (V-BM#) | IP Addresses |
| 0 | a b c d |
| 1 | e f g h |
| . . . | . . . |
| N | w x y z |

Visited bearer managers 26a may be listed in the configuration table according to their respective IP addresses (e.g., in ascending numerical order of their IP addresses). In particular embodiments, each IP gateway 28 may respectively maintain configuration tables of identical length and may apply identical selection algorithms. Maintaining approximately uniform correlation tables and utilizing identical selection techniques across IP gateways 28 may increase the likelihood that endpoint 12 will resolve to the same visited bearer manger 26a, no matter which IP gateway 28 is responsible for visited bearer manager selection. In particular embodiments, the number of visited bearer managers 26a included in the configuration table may be a predetermined number of selected bearer managers (e.g., all of the bearer managers residing in visited network 14a).

In network configurations with full connectivity (e.g., where every IP gateway 28 in visited network 14a has access to every visited bearer manager 26a), the configuration tables at each IP gateway 28 may naturally be identical in length and arrangement, thus allowing the selection algorithm to resolve endpoint 12 to the same visited bearer manager 26a regardless of which IP gateway is used. In particular embodiments, use of the selection algorithm in conjunction with configuration tables of equal lengths may increase the likelihood that endpoint 12 will be reconnected to the same visited bearer manager 26a during handoff between IP gateways 28, thereby avoiding possible mobility binding updates (e.g., re-registration, re-authentication, etc) associated with switching between visited bearer managers 26a.

In network configurations with partial connectivity (e.g., where every IP gateway in visited network 14 does not have access to every visited bearer manager 26a), configuration tables of equal lengths may be achieved by inserting “dummy” entries into the configuration tables as place holders for the missing bearer managers. As an example and not by way of limitation, IP gateway 28 may be capable of inserting dummy entries into its configuration table to represent particular visited bearer managers 26a that exist in visited network 14 but which are not accessible to IP gateway 28 because the particular visited bearer mangers 26a are, for example, offline, over loaded, inactive, inaccessible, etc. Each dummy address may occupy the position in the configuration table that the “real” visited bearer manager IP address would have occupied had IP gateway 28 maintained connectivity with the inaccessible visited bearer manager. In particular embodiments, the dummy IP addresses may be set to 0.0.0.0. Once a configuration table has been populated with IP addresses, the entries may be numbered from 0 to N in ascending order—yielding N+1 entries in the configuration table.

The selection algorithm employed by IP gateway 28 may be any mathematical formula capable of approximately evenly distributing the MSIDs associated with endpoints 12 across the finite number of visited bearer managers entries in the configuration table. As an example and not by way of limitation, IP gateway 28 may use a modulo algorithm for initial selection and assignment of visited bearer manager 26a to endpoint 12 and for reselection and reassignment of visited bearer manager 26a to endpoint 12 (e.g., during handoff). As an example and not by way of limitation, IP gateway may apply the following algorithm for initial selection of visited bearer manager 26a:

V-BM#=(truncated IMSI)modulo N+1

where truncated IMSI may be defined as the least significant four digits of the IMSI of endpoint 12 (taken as a decimal value), V-BM# may be defined as the visited bearer manger entry, and N may be defined as the number of visited bearer managers addresses contained in the configuration table. The IP address of the selected visited bearer manager may obtained by indexing at the designated V-BM# in the configuration table. One of ordinary skill in the are will recognize that the IMSI number is used for the sake of explanatory simplicity and will further recognize that any suitable MSID or variation thereof may be tailored for use in the selection algorithm. Moreover, one of ordinary skill in the art will recognize that V-BM# may represent any value suitable for selecting a bearer manger from the configuration table.

If the selected visited bearer manager entry is a dummy entry or is otherwise inactive (e.g., if the selected visited bearer manager does not reply to the registration request or replies with a code other than “Registration accepted”), IP gateway 28 may select another visited bearer manger by performing the following selection algorithm, up to N times, until a non-dummy IP Address entry is located in the configuration table:

V-BM#=(V-BM#+1)modulo N+1

Thus, in particular embodiments, the distributive selection technique may take into account dynamic factors such as the call volume on system 10, the geographic location of visited bearer managers 26a, the operational capacity of each visited bearer manager 26a (e.g., on-line or off-line), and other factors affecting the performance of visited bearer managers 26a. As a result, particular embodiments provide a flexible mechanism for dynamic allocation of visited bearer managers 26a in a roaming scenario. Once IP gateway 28 obtains a functional IP address for visited bearer manager 26a, IP gateway 28 may provide the visited address to endpoint 12 in the DHCP response.

One of ordinary skill in the are will recognize that the arrangement of the configuration table and the associated selection algorithms were described for the purpose of explanatory simplicity and will further recognized that any combination of selection algorithms (or other selection techniques) and configuration table arrangements may be used to evenly distribute endpoints 12 among bearer mangers 26a.

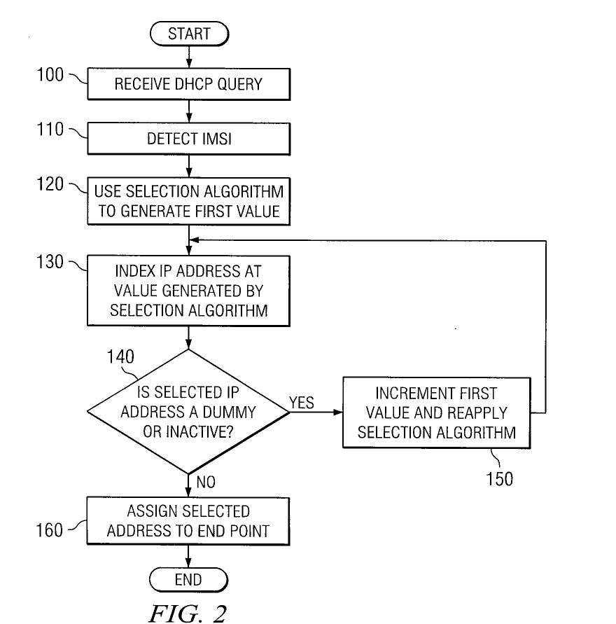

FIG. 2 illustrates an example method for visited bearer manager selection. The method begins at step 100 where IP gateway 28 receives a DHCP query from endpoint 12 requesting a visited address. The method continues at step 110 where IP gateway 28 retrieves the MSID associated with endpoint 12. At step 120, IP gateway 28 applies a selection algorithm to the MSID to generate a V-BM#. The method continues at step 130 where IP gateway 28 indexes the IP address at the V-BM# generated by the selection algorithm. At step 140, the selected IP address is checked to determine whether it is a dummy address or is otherwise inactive or unusable. If the selected address is a dummy or is otherwise inactive or unusable, the method continues at step 150 where the V-BM# is incremented by one and the selection algorithm is reapplied. Thereafter, the method returns to step 130 and is repeated up to N times until a useable address is found. If the selected address is a useable address, the method continues at step 160 where the address is assigned to endpoint 12 after which, the method ends.

Although particular steps of the method illustrated in FIG. 2 are described and illustrated as occurring in a particular order, the present disclosure contemplates any suitable steps of the method illustrated in FIG. 2 occurring in any suitable order. Moreover, although particular components of FIG. 1 are described and illustrated as executing particular steps of the method illustrated in FIG. 2, the present disclosure contemplates any suitable components executing any suitable steps of the method illustrated in FIG. 2.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. A method, comprising:
at an Internet Protocol gateway (IPGW):
generating a first value corresponding to an identifier (ID) of an access terminal (AT);
identifying a first one of a plurality of visited bearer managers (VBMs) based on a correlation between the first value and a first Internet Protocol (IP) address of the first VBM; and
determining a usability of the first VBM for the AT, the determination of the usability of the first VBM taking into account dynamic conditions at the first VBM.

2. The method of claim 1, further comprising, at the IPGW, if the first VBM is usable for the AT, allowing connection between the AT and the first VBM.

3. The method of claim 1, further comprising, at the IPGW:
if the first VBM is unusable for the AT:
generating a second value corresponding to a modification of the first value;
identifying a second one of the VBMs based on a correlation between the second value and a second IP address of the second VBM;
determining a usability of the second VBM for the AT, the determination of the usability of the second VBM taking into account dynamic conditions at the second VBM; and
if the second VBM is usable for the AT, allowing connection between the AT and the second VBM.

4. The method of claim 1, wherein the ID comprises a Mobile Station Identifier (MSID) mapped to the AT.

5. The method of claim 1, wherein the ID comprises an international mobile station identifier (IMSI).

6. The method of claim 1, wherein the ID comprises a media access control (MAC) address.

7. The method of claim 1, wherein the ID comprises a unicast access terminal identifier (UATI).

8. The method of claim 1, wherein generating the first value comprises applying a modulo function to a numerical representation of the ID of the AT.

9. The method of claim 8, wherein the numerical representation derives from a truncation of the ID of the AT.

10. The method of claim 8, where applying the modulo function to the numerical representation of the ID of the AT comprises dividing the numerical representation of the ID by a predetermined integer, the first value comprising a remainder of the division.

11. The method of claim 10, wherein the predetermined integer equals a number of selected VBMs.

12. The method of claim 11, wherein the selected VBMs comprise one or more dummy VBMs.

13. The method of claim 1, wherein identifying the first VBM based on a correlation between the first value and a first IP address of the first VBM comprises mapping the first value to the first IP address in a configuration table comprising IP addresses of the plurality of VBMs.

14. The method claim 3, wherein generating the second value comprises applying a modulo function to the first value incremented by one.

15. An apparatus comprising:
one or more processors; and
a memory coupled to the processors comprising instructions executable by the processors, the processors operable when executing the instructions to:
generate a first value corresponding to an identifier (ID) of an access terminal (AT);
identify a first one of a plurality of visited bearer managers (VBMs) based on a correlation between the first value and a first Internet Protocol (IP) address of the first VBM; and
determine a usability of the first VBM for the AT, the determination of the usability of the first VBM taking into account dynamic conditions at the first VBM.

16. The apparatus of claim 15, wherein the processors are further operable when executing the instructions to, if the first VBM is usable for the AT, allow connection between the AT and the first VBM.

17. The apparatus of claim 15, wherein the processors are further operable when executing the instructions to:
if the first VBM is unusable for the AT:
generate a second value corresponding to a modification of the first value;
identify a second one of the VBMs based on a correlation between the second value and a second IP address of the second VBM;
determine a usability of the second VBM for the AT, the determination of the usability of the second VBM taking into account dynamic conditions at the second VBM; and
if the second VBM is usable for the AT, allow connection between the AT and the second VBM.

18. The apparatus of claim 15, wherein the ID comprises a Mobile Station Identifier (MSID) mapped to the AT.

19. The apparatus of claim 15, wherein the ID comprises an international mobile station identifier (IMSI).

20. The apparatus of claim 15, wherein the ID comprises a media access control (MAC) address.

21. The apparatus of claim 15, wherein the ID comprises a unicast access terminal identifier (UATI).

22. The apparatus of claim 15, wherein the processors are operable to generate the first value by applying a modulo function to a numerical representation of the ID of the AT.

23. The apparatus of claim 22, wherein the numerical representation derives from a truncation of the ID of the AT.

24. The apparatus of claim 22, wherein the processors apply the modulo function to the numerical representation of the ID of the AT by dividing the numerical representation of the ID by a predetermined integer, the first value comprising a remainder of the division.

25. The apparatus of claim 24, wherein the predetermined integer equals a number of selected VBMs.

26. The apparatus of claim 25, wherein the selected VBMs comprise one or more dummy VBMs.

27. The apparatus of claim 15, wherein the processors are operable to identify the first VBM based on a correlation between the first value and a first IP address of the first VBM by mapping the first value to the first IP address in a configurations table comprising IP addresses of the plurality of VBMs.

28. The apparatus of claim 17, wherein the processors generate the second value by applying a modulo function to the first value incremented by one.

29. A system comprising:
a plurality of Visited Bearer Managers (VBMs);
an Internet Protocol Gateway (IPGW) coupled to at least some of the VBMs, the IPGW operable to:
generate a first value corresponding to an identifier (ID) of an access terminal (AT);
identify a first one of the plurality of VBMs based on a correlation between the first value and a first Internet Protocol (IP) address of the first VBM; and
determine a usability of the first VBM for the AT, the determination of the usability of the first VBM taking into account dynamic conditions at the first VBM.

30. The system of claim 29, wherein the IPGW is further operable to, if the first VBM is usable for the AT, allow connection between the AT and the first VBM.

31. The system of claim 29, wherein the IPGW is further operable to:
if the first VBM is unusable for the AT:
generate a second value corresponding to a modification of the first value;
identify a second one of the VBMs based on a correlation between the second value and a second IP address of the second VBM;
determine a usability of the second VBM for the AT, the determination of the usability of the second VBM taking into account dynamic conditions at the second VBM; and
if the second VBM is usable for the AT, allow connection between the AT and the second VBM.
